(19) United States
(12) Patent Application Publication
(10) Pub. No.: US 2009/0055300 A1
(43) Pub. Date: Feb. 26, 2009

(54) Method and system for remote generation of renewable energy

(76) Inventor: Grant McDowell, Marrickville (AU)

Correspondence Address: TIAJOLOFF & KELLY, CHRYSLER BUILDING, 37TH FLOOR, 405 LEXINGTON AVENUE, NEW YORK, NY, 10174, US

(21) Appl. No.: 12/218,507

(22) Filed: Jul. 15, 2008

(30) Foreign Application Priority Data
Jul. 17, 2007 (AU) 2007903872

(51) Int. Cl. G06Q 30/00; G06Q 10/00

(52) U.S. Cl. 705/34; 705/412; 705/1

(57) ABSTRACT

A method and system for determining a net energy consumption are described. Information is received descriptive of a power output generated by at least one source of renewable energy (1) associated with a user (100). Further information describes power consumption at premises (102) associated with the user and located remotely from the at least one source of renewable energy (1). A difference is determined between a value of the power consumption and a value of the power output. An energy bill may be generated dependent on the difference.

### FIELD OF THE INVENTION

The present invention relates to a method and system for the generation and management of renewable energy and, in particular, to a system in which a user is credited with renewable energy generated at a remote location.

### BACKGROUND OF THE INVENTION

In recent decades there has been a move towards the use of renewable resources to generate energy. Conventional systems based on the combustion of fossil fuels are seen to be having a detrimental effect on the environment. Although coal-fired power stations will be constructed and used for the foreseeable future, energy generation is increasingly being supplemented by sources such as solar power, wind generation, hydro-electric schemes and geothermal energy.

Solar panels for converting solar energy to electricity have increased greatly in efficiency and popularity and are often incorporated in residential or business premises. However, solar technology still has some limitations. There is a relatively lengthy period before the savings from the generated electricity offset the initial capital outlay. This is a disincentive for home owners to install solar panels, as it is quite possible that they will move from the premises before they see any financial saving from the installed panels.

In addition, it is not always convenient to retrofit solar panels to existing buildings. There may not be sufficient space, or the installation may be considered aesthetically unacceptable. Problems also arise in cities where people live in apartment blocks. An individual apartment owner may not be in a position to have solar panels installed on a building without support from the other owners and residents.

In some cases, a person may wish to use renewable energy resources, but may face restrictions due to an inappropriate climate or local geographical constraints such as living in the shadow of surrounding buildings.

There is an ongoing need to enable energy consumers to make use of renewable energy resources in a convenient and efficient manner.

### SUMMARY OF THE INVENTION

It is an object of the present invention to substantially overcome, or at least ameliorate, one or more disadvantages of existing arrangements.

According to a first aspect of the invention there is provided a method for determining a net energy consumption comprising:

receiving information descriptive of a power output generated by at least one source of renewable energy associated with a user;

receiving information descriptive of power consumption at premises associated with the user and located remotely from the at least one source of renewable energy; and

determining a difference between a value of the power consumption and a value of the power output.

According to a second aspect of the invention there is provided an apparatus for determining a net energy consumption comprising:

means for receiving information descriptive of a power output generated by at least one source of renewable energy associated with a user;

means for receiving information descriptive of power consumption at premises associated with the user and located remotely from the at least one source of renewable energy; and

means for determining a difference between a value of the power consumption and a value of the power output.

According to a further aspect of the invention there is provided a system for remotely generating electrical power from solar energy comprising

a plurality of units for generating electrical power from solar energy, said units being associated with at least one user;

a monitoring system arranged to measure a power output of said plurality of units and to apportion the measured power output to the at least one user;

a data output to send data descriptive of the apportioned power output to offset a power consumption at premises associated with the at least one user and located remote from said plurality of units.

According to a further aspect of the invention there is provided a system for supplying electrical power comprising:

a plurality of units for generating electrical power from solar energy, said units being associated with at least one user;

a first monitoring system arranged to measure a power output of said plurality of units and to apportion the measured power output to the at least one user;

a data output to send data descriptive of the apportioned power output;

a power distribution system configured to supply electrical power to one or more premises associated with the at least one user, the premises being located remote from the plurality of units;

a second monitoring system arranged to measure a power consumption at the one or more premises; and

an accounting system operable to determine a net energy usage for the at least one user based on an offset between the measured power consumption and the apportioned power output.

### BRIEF DESCRIPTION OF THE DRAWINGS

Embodiments of the present invention will now be described with reference to the drawings, in which:

FIG. 1 shows schematically a system in which an array of solar panels feeds electrical power into a distribution grid;

FIG. 2 shows schematically a system in which a household receives electrical power over a distribution grid with links to a remote source of renewable energy;

FIG. 3 shows a schematic diagram of a system for generating and monitoring renewable energy;

FIG. 4 shows schematically a data structure for use in the system of FIG. 3;

FIG. 5 is a flow diagram of a method of administering the system of FIG. 2;

FIG. 6 is a schematic block diagram of a system for implementing the method of FIG. 5; and

FIG. 7 is a schematic diagram of a data structure for use in the system of FIG. 6.

### DETAILED DESCRIPTION OF THE EMBODIMENTS

In the described arrangements, a user may purchase one or more units that generate renewable energy. These units may be situated remote from the residential or business premises used by the owner of the renewable energy units. The energy generated by the units is fed into a distribution grid and the user's energy consumption is offset by the energy generated by the user's renewable energy units.

By purchasing sufficient units that generate renewable energy, a user may become energy neutral, or even become a net supplier of energy.

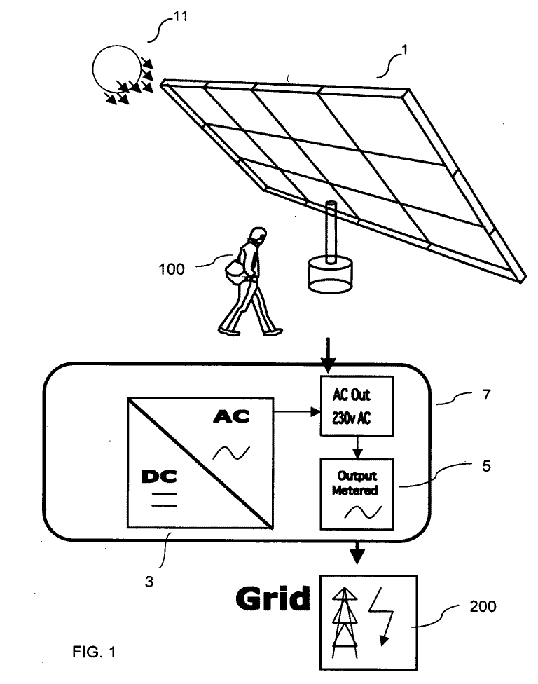

In one arrangement, the renewable energy units are solar panels. For example, as illustrated in FIG. 1, a user 100 may purchase one or more solar panels in an array 1 of solar panels. The systems described herein do not depend on any particular type of solar energy generation. However, in the example shown the array 1 is made up of high-quality solar panels constructed into rectangular frames anchored to the ground by concrete blocks. The frame is erected in an array of twelve panels arranged in a grid of 4 panels wide by 3 panels high. A tracking device and motor may be used to adjust the orientation of the array 1 to compensate for the changing direction of rays from the sun 11. In other arrangements the panels are fixed in position and mounted to a rigid steel structure.

The solar panel array 1 is associated with a control system 7 that monitors and controls the operation of the array 1.

The solar panels generate DC power, which is converted to AC power by inverter 3. The control system 7 may also provide further signal conditioning to ensure that the power output of the array 1 is compatible with a distribution grid 200 into which the output power is fed. In one arrangement, the AC output may have a rating of 230 volts. However, this will depend on local requirements, and other voltage ratings may be used.

The control system 7 also includes meters 5 to measure the power generated by the solar array 1. The meters 5 enable the power generated by the solar panels 1 to be credited to the user 100.

Various metering arrangements may be used. For example, the power output of each individual panel in the array 1 may be measured. In this way, the user 100 may be credited dependent on the exact power output of each individual panel owned by the user 100. Alternatively, the meters 5 may measure the total output of the array 1, and the user 100 may be credited with an appropriate fraction of the total power generated, depending on the number of panels owned by the user 100. The latter arrangement provides some averaging if there are variations in the performance of individual solar panels. In addition, in the latter arrangement the user 100 is not unduly disadvantaged by the temporary failure or decommissioning of individual panels owned by the user 100.

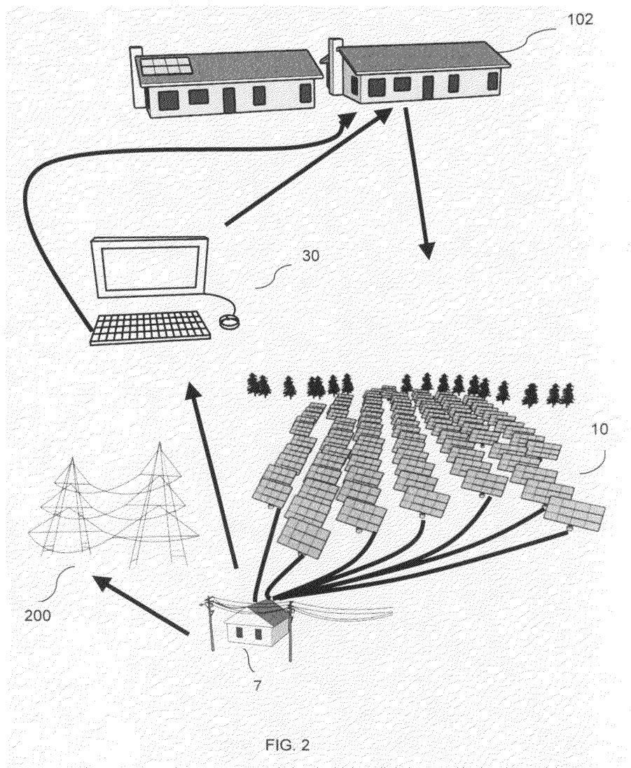

The system is further illustrated in FIG. 2, which shows a solar energy farm 10 that includes a plurality of solar panel arrays 1. Such a solar farm 10 offers economies of scale, for example in the provision of the control system 7 for monitoring and controlling operation of multiple solar panels 1. The solar farm arrangement 10 also has the advantage that it may be located in a suitably sunny location. In locations away from cities, there is also likely to be more space available to install solar panel arrays 1 that can move to adjust to the sun's progress. In contrast, where solar panels are provided on or incorporated into a building, it is less convenient to provide such solar tracking capabilities.

The user 100 may purchase one or more solar panels in the solar farm 10. It will be appreciated that other forms of renewable energy may also be used in a similar structure. For example, the user 100 may purchase a unit in a wind farm at a remote location comprising a plurality of wind generation units.

The user 100 may be charged a levy to pay for the management and maintenance of the units owned by the user. The levy may be a specified monetary amount, or may be charged as a proportion of the power output. For example, 3% of the kilowatt hours generated by the user's units may be ascribed to the solar energy farm 10 as a levy.

The power output of the solar farm 10 is appropriately conditioned by the control system 7 and fed into a distribution grid 200.

The user 100 has associated premises 102, which may be a home or a place of business. Energy is consumed at the premises 102, for example by household appliances, heating and lighting. Energy is supplied to the premises 102 from the distribution grid 200. In alternative arrangements, the solar farm 10 may be sufficiently remote from the user's premises 102 that there may be no common distribution grid 200 linking the solar farm 10 and premises 102. For example, the solar farm 10 and premises 102 may be in different states, countries or even different continents. In this description the term “remote” indicates that the generation units are not used to directly provide power to the premises, typically due to geographic separation.

A communication link 30, for example the internet, may be provided between the control system 7 and the user's premises 102. This communication link may be used to inform the user 100 of the status of the panels owned by the user 100.

The illustrations show a single solar farm 10 and a single set of buildings 102. However, it will be understood that the system may include multiple farms for the production of renewable energy and multiple user premises 102.

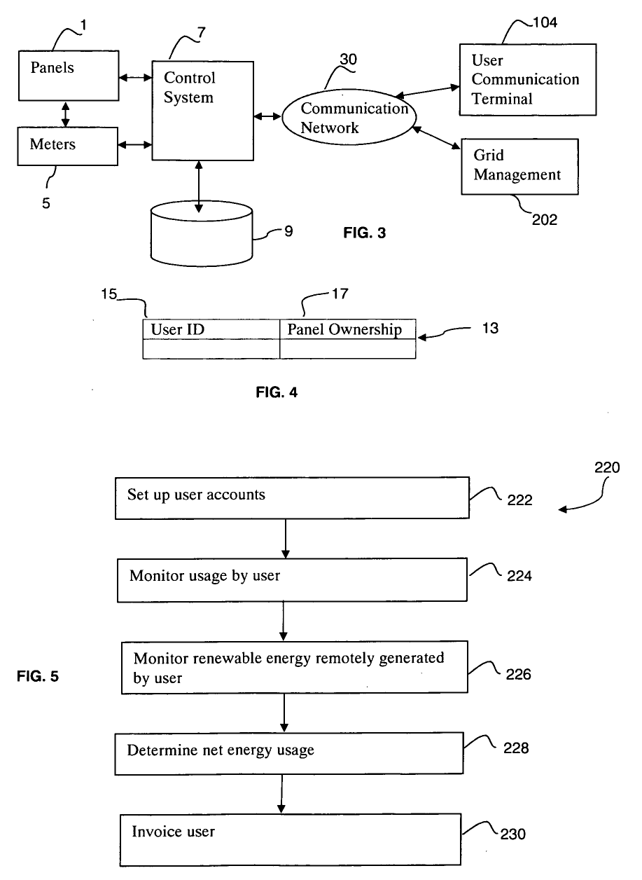

FIG. 3 shows a further schematic diagram of the solar farm system. The control system 7 monitors and controls the solar panel arrays 1. The meters 5 monitor the power output of the panels 1 and provide the measured information to the control system 7. The generated power is fed into distribution grid 200. A database 9 is associated with the control system 7 for the solar farm 10. The database 9 may be used to keep track of the ownership of individual solar panels. FIG. 4 shows schematically a data structure 13 in which a user ID 15 that identifies each of the users 100 is associated with information 17 that identifies the solar panels owned by each of the individual users 100. The ownership details 17 may identify specific physical units. Alternatively, the ownership information 17 may identify a user's share of a larger unit such as the entire solar farm 10 or a group of solar panel arrays 1.

The control system 7 is linked to a communication network 30, such as the internet, enabling communication of information from the solar farm 10 to a user communication terminal 104. This may, for example, be a personal computer owned by the user 100, or other communication devices such as a mobile phone or PDA. The communication link 30 enables the control system 7 to update the user 100 about the power generated by the solar farm 10, and may also communicate messages to the user, for example about maintenance or expansion of the solar farm 10.

As shown in FIG. 3, the communication network 30 also permits communication to a grid management system 202 used in the management and control of the distribution grid 200.

The communication between the control system 7 and the grid management 202 may be via the internet or may be through a proprietary communication network.

This is illustrated further in FIG. 6. In the depicted arrangement, the grid management 202 includes an internal communication network 206, such as an intranet or local area network (LAN). One or more management servers 204 are included in the grid management system 202, running software used to monitor and manage the operation of the distribution grid 200.

The grid management system 202 also includes one or more accounting systems 208 linked to the internal communication network 206 and operable to manage accounting systems for the distribution grid 200. The accounting functions may be provided by software running on standard computer systems. The grid management system 202 may be widely distributed geographically, with the different components 204, 208 and 210 linked by the communication network 206. The grid management system 202 further includes one or more databases 210 used to store information about users of the distribution grid 200.

Power from the distribution grid 200 is provided to the user's premises 102. Power usage at the premises 102 is monitored by local meters 106. Readings from the metering 106 are fed back to the grid management system 202. There may be a direct communication link from the meters 106 to the grid management 202. Alternatively, there may be manual reading of the meters 106, with the manual readings being subsequently entered into data entry facilities of the grid management 202.

The metering 106 for the user's premises 102 may include one or more bidirectional meters. In this case the user's credits based on the generation of renewable energy may be used to reverse the direction of the meters 106. For example, a signal indicative of the user's renewable energy credits may be sent from grid management system 202 to the metering 106 to reduce the consumption measurements.

The metered output of the renewable energy farm 10 is also provided to the grid management 202. This is typically by an electronic link for greater efficiency.

FIG. 5 shows a flowchart of a method 220 that may be implemented on the grid management system 202 to invoice the user 100 in light of the user's ownership of renewable energy resources.

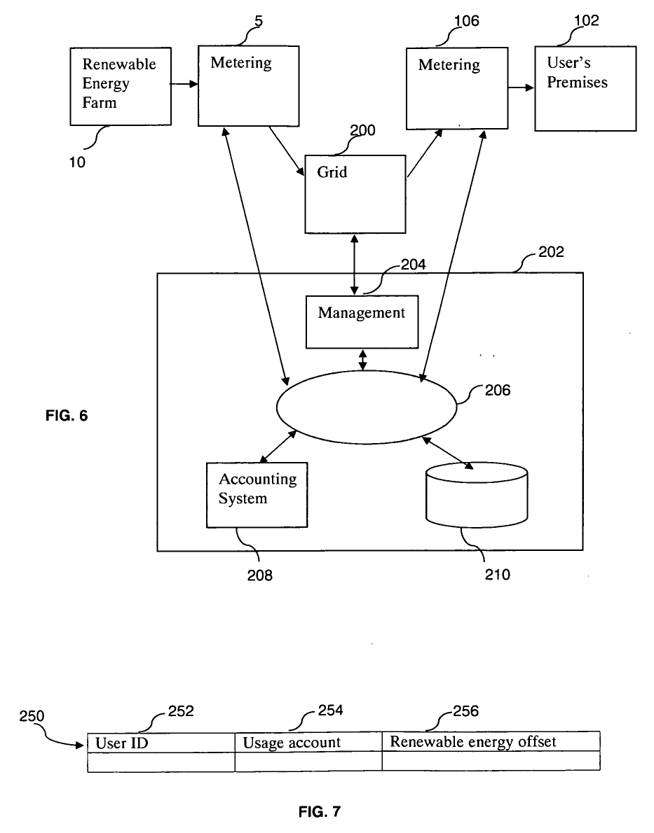

In process 222, accounts are set up for the user. Typically, software running on standard computer equipment may be used to display prompts in order to capture the required information. FIG. 7 illustrates schematically a data structure 250 that may be used in setting up the user account. The information may, for example, be stored in database 210. The data structure 250 includes information 252 that identifies each of the users 100. There is associated information 254 that identifies one or more accounts relating to premises where the user 100 consumes energy. The usage account may, for example, relate to power consumption at a user's home or business premises 102.

The data structure 250 also includes information 256 that identifies the user's ownership of units at the renewable energy farm 10.

In process 224 the system monitors power usage by the user at the locations identified by the usage accounts 254. The usages are measured by the meters 106 as mentioned above and the measurements may be communicated electronically to the grid management system 202. Alternatively, the meter readings may be captured manually and subsequently entered into data capture terminals of the grid management system 202.

In process 226 the grid management system 202 monitors how much renewable energy is remotely generated by the user 100. This monitoring is typically based on information transmitted from the solar farm control system 7, including the measurements made by the meters 5.

In process 228, accounting software, for example running on accounting server 208 determines a net energy usage of the user 100. Based on this determination, in process 230 the grid management system 202 invoices the user 100. An invoice may be generated, for example, once a month to reflect energy consumption and generation in the previous month.

The user's energy consumption is thus offset by the renewable energy produced by the units owned by the user. The user may be energy neutral or may even be a net producer of energy. The invoice and information about the user's overall consumption may be provided to the user by various standard means. For example, the information may be transmitted via the internet, or by standard mail.

The energy usage at the user's premises 102 may be charged at a variable rate. For example, the cost of electricity may be higher during peak periods than at other times. Furthermore, the user may be charged at a higher rate if energy consumption at the premises 102 exceeds a specified threshold.

The value of the renewable energy generated at energy farm 10 may also vary, and such variation may be included in the determination of the user's net usage in process 228. Thus in one arrangement the user's energy consumption may be offset by the absolute power generated at the farm 10 (for example in kilowatt hours). Alternatively, the offset may depend on a current market value of the renewable energy generated at the energy farm 10.

The described arrangement have the advantage that the user's renewable energy resources are owned independently of the residential or business premises 102. Thus, for example, if the user 100 moves home, the details of the user's new address need simply be updated in entry 254 of the data structure 250. The user's renewable energy units are then offset against energy consumption at the new address. This makes it more likely that the user will see a financial benefit from a return on his or her investment in the renewable energy resources.

Ownership of the solar panels may be traded with ease, as there is no dismantling and construction involved as in the case of current rooftop systems.

Renewable energy electricity rates are improving as the market for green energy drives prices up. As the price of green energy increases, the return on investment improves greatly, reducing the years required to repay the investment in the renewable energy resources.

In the described arrangements, there is a single grid management system 202 that monitors both the renewable energy generated and the user's energy consumption. In alternative arrangements, the renewable energy may be fed into a different grid to that which supplies the user's premises 102. In this case, there may be a further exchange of information between different grid management systems. For example, a first grid management system may receive information from the renewable energy farm 10. This information may be subsequently transferred to a second grid management system that manages a grid supplying power to the user's premises 102.

It will be understood that the invention disclosed and defined in this specification extends to all alternative combinations of two or more of the individual features mentioned or evident from the text or drawings. All of these different combinations constitute various alternative aspects of the invention.

I claim:

1. A method for determining a net energy consumption comprising:
receiving information descriptive of a power output generated by at least one source of renewable energy associated with a user;
receiving information descriptive of power consumption at premises associated with the user, wherein the premises are located remotely from the at least one source of renewable energy; and
determining a difference between a value of the power consumption and a value of the power output.

2. A method according to claim 1 comprising:
generating an energy bill dependent on the determined difference.

3. A method according to claim 1 wherein the source of renewable energy generates electrical power from solar energy.

4. A method according to claim 1 comprising:
receiving a first market rate for the power output; and
receiving a second market rate for the power consumption,
wherein the difference is determined dependent on the first market rate and the second market rate.

5. A method according to claim 4 wherein at least one of the first market rate and the second market rate vary with time.

6. An apparatus for determining a net energy consumption comprising:
means for receiving information descriptive of a power output generated by at least one source of renewable energy associated with a user;
means for receiving information descriptive of power consumption at premises associated with the user and located remotely from the at least one source of renewable energy; and
means for determining a difference between a value of the power consumption and a value of the power output.

7. A computer program product comprising machine-readable program code recorded on a machine-readable recording medium for controlling the operation of a data processing apparatus on which the program code executes to perform a method for determining a net energy consumption comprising:
receiving information descriptive of a power output generated by at least one source of renewable energy associated with a user;
receiving information descriptive of power consumption at premises associated with the user and located remotely from the at least one source of renewable energy; and
determining a difference between a value of the power consumption and a value of the power output.

8. A system for remotely generating electrical power from solar energy comprising
a plurality of units for generating electrical power from solar energy, said units being associated with at least one user;
a monitoring system arranged to measure a power output of said plurality of units and to apportion the measured power output to the at least one user;
a data output to send data descriptive of the apportioned power output to offset a power consumption at premises associated with the at least one user and located remote from said plurality of units.

9. A system for supplying electrical power comprising:
a plurality of units for generating electrical power from solar energy, said units being associated with at least one user;
a first monitoring system arranged to measure a power output of said plurality of units and to apportion the measured power output to the at least one user;
a data output to send data descriptive of the apportioned power output;
a power distribution system configured to supply electrical power to one or more premises associated with the at least one user, the premises being located remote from the plurality of units;
a second monitoring system arranged to measure a power consumption at the one or more premises; and
an accounting system operable to determine an energy credit or debit for the at least one user based on an offset between the measured power consumption and the apportioned power output.

10. A system according to claim 9 wherein the electrical power generated by the plurality of units is supplied to a second power distribution system different to the power distribution network.
